(19) United States
(12) Patent Application Publication
(10) Pub. No.: US 2004/0199912 A1
(43) Pub. Date: Oct. 7, 2004

(54) Method system and program product to retrieve and distribute information on demand

(76) Inventor: Chris Fook-Choong Foo, Costa Mesa, CA (US)

Correspondence Address: Chris Foo, P.O. Box 28151, Santa Ana, CA, 92799, US

(21) Appl. No.: 10/372,844

(22) Filed: Feb. 26, 2003

(51) Int. Cl. G06F 15/16

(52) U.S. Cl. 718/100; 718/102

(57) ABSTRACT

This method and system is used to retrieve and distribute information on demand. This system was developed to connect computers and execute any applications or custom programs remotely, regardless of platforms, and to distribute the information for instant viewing anywhere anytime. This system bridges the gap between programs generating data and programs distributing data to the end user in need of the information. This method would leverage the connectivity of internet technologies and allow easy access to the business logic that had already been coded to create custom reports or to execute remote process via a standard browser.

### BACKGROUND

Companies often have various systems in heterogeneous environments, potentially in various locations. Secured data dissemination across the enterprise is usually difficult, inefficient, and costly. To address these concerns, this system is built as a three-tier open architecture environment with integrated intranet technology, providing various services to deliver integrated solutions for managing data from various back-end applications.

### SUMMARY

The method system used in the program product will:

1. connect to computers resided on any platforms and retrieve information on demand without having to reengineer the system.

2. provide features that allow users to access and share information generated from remote programs residing on different platforms.

3. provide an easy and inexpensive solution for the distribution of business reports, files, data and critical information on demand.

4. allow companies to manage the immediate distribution of critical information while insuring that information is distributed only to authorized personnel.

5. save time by ensuring uniform communications with all parties, thus reducing overhead costs, creating new revenue opportunities and strengthening relationships with business partners.

6. extend the useful life and functionality of existing computer programs.

7. retrieve and distribute critical information on demand regardless of where the users are located, regardless of where the systems are, and regardless of what platforms the programs are running.

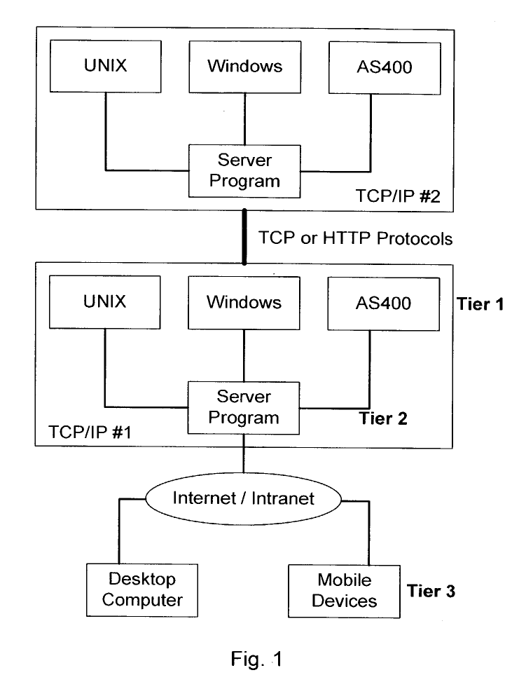

FIG. 1 is a networking diagram including participants of a group connected to the network.

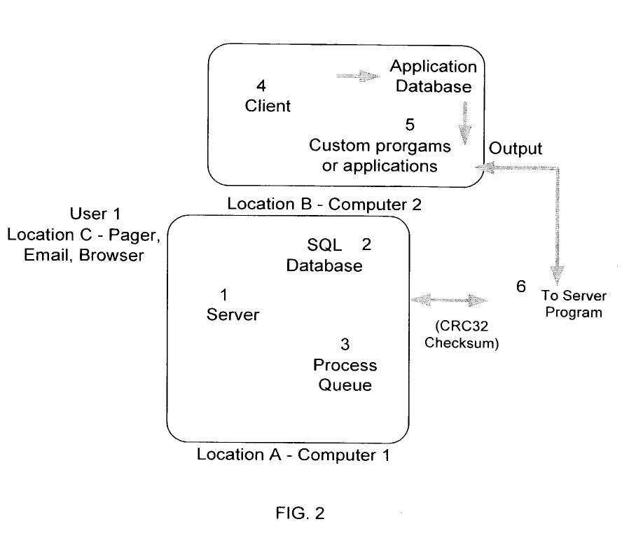

FIG. 2 illustrates the client and server process flow diagram.

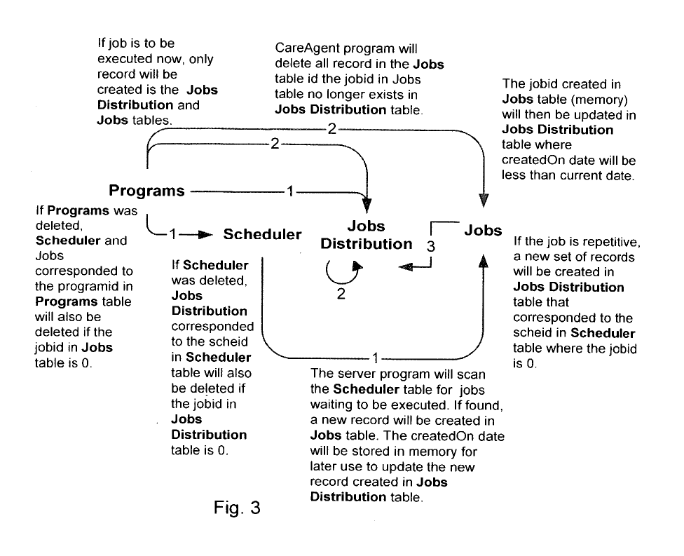

FIG. 3 illustrates the programming logic in the server program. All tables described are resided in server computer in Tier 2 of FIG. 1. CareAgent program is part of the server program whose specific tasks include monitoring the status of server program, sending alert notifications if server program failed to function.

### DETAILED DESCRIPTION

FIG. 1

1. Tier 1 is composed of several application servers. They are usually referred to as the “back-end servers”. This collection of application servers can operate within a heterogeneous mix of environments such as Windows, AS/400, or UNIX.

2. Tier 1 servers are usually set up to handle a variety of software applications for business management, such as databases, or financial analysis.

3. Most of the server-based custom programs are normally used to generate reports from their applications, which also reside on the Tier 1 servers.

4. The information stored on the back-end is often difficult to be retrieved. Running the query for retrieving data from the database takes only few seconds, but setting up all the server-based programs and delivering the information on demand requires months of programming. Not to mention the countless hours of telephone inquiries to the programmer who finally executes the programs and receives the reports.

5. The Client daemon program will be installed on every computer in Tier 1. It is constantly listening on the port. The port number and host name are uniquely identifying the client's computer.

6. The Server program residing in Tier 2 will constantly query tasks from the database and create a task identifier to be transmitted to client's computer for execution.

7. The task identifier consists of the information from the targeting client's computer, and the program name (including path and parameters) that will be executed in client's computer.

8. Not only will the server program be able to open socket connections communication with the client daemon program, but it will also be able to open socket connections to communicate with other server program within different networks. This server-to-server inter-network connection provides another method to transfer data without passing the data through the Value Added Network (VAN). This data can be in Electronic Data Interchange (EDI) standards, or any other proprietary standards.

9. The server and client daemon program can be developed using any programming language, but it operates best when it is developed in a Java programming language, which requires only a minimal Java Runtime environment when installed in the computer.

10. The server program creates a task identifier using the information stored on the database. The task identifier will be entered during the program configuration requiring only a one-time set up process.

11. The server program will constantly query the database searching for tasks. The server program-processing interval is defined in the properties file that is associated with the server program.

12. The user can click on the hyperlink associated with configured program in the system and schedule the program to be executed in real-time or in batch mode.

13. Upon completion of the execution process in client's computer, the output generated will be transmitted back to the server computer for archiving as well as displaying on the web browser. This method provides for real time on-demand information delivery, regardless of the user's location.

14. The hyperlink interface was developed in Hypertext Markup Language (HTML), Java Server Pages (JSP) and JavaScript.

15. Tier 3 devices can be desktop computers, cell phones, or PDA devices.

FIG. 2

16. Server program constantly queries the SQL database (2) and creates tasks identifier in the process queue (3) based on process priority.

17. The server program opens socket connections with client's computer where the program tasks will be executing.

18. The tasks identifier is encrypted compress as well as inserted a crc32 check sum value to ensure the integrity of the tasks identifier.

19. Client daemon program constantly listens for incoming connections from remote computers on a specific port (4) then decrypts and verifies the crc32 check sum value to ensure the command was received successfully.

20. Client daemon program obtains a single instance of current runtime from getRuntime method class (5) and interfaces with the client's operating systems environment to execute the custom program.

21. Upon completion of the execution process, the client program encrypts, compresses, and inserts a crc32 check sum into the data steams, and transmits the output back to the server computer.

22. Server computer decrypts, validates crc32 check sum (6), archives the received information, and then updates the appropriate tables in the database.

23. The server interface is a web based application where user can access remotely with a browser by clicking on a hyperlink to view the information retrieved from the client's computer. The interface provides other features to redistribute the information to other users or groups by inserting new record in the database.

24. The server interface only retrieves records pertaining to the users, from the tables in a hyperlink format displayed on the browser.

What is claimed is:

1. A computer-implemented method for connecting computers over a network and distribute information on demand, the method comprising: receiving a task identifier associated with a remote program; encrypting the task identifier; transmitting tasks identifier to remote client daemon for execution; retrieving output from remote client program; encrypting and storing retrieved output for viewing on the browser.

2. The method of claim 1, wherein the task identifier comprises one of static and binary content.

3. The method of claim 1, wherein remote program is any software application resided on a different computer connecting via TCP/IP protocol.

4. The method of claim 2, wherein binary content further comprises remote program name; remote execution command; remote program path; and output filename.

5. The method of claim 1, wherein encrypting step further comprises compressing the task identifier using standard compressing routines.

6. The method of claim 5, wherein compressing step further comprises inserting extra bits and repositions the compressed bits.

7. The method of claim 1, wherein remote client daemon is a program listens for incoming connections from remote computer on a specific port and interacts with them.

8. The method of claim 1, wherein transmitting step further comprises making socket connection to remote client daemon program.

9. The method of claim 7, wherein specific port comprises one static number ranging from 1024-9999 uniquely for every computer.

10. The method of claim 1, wherein execution step further comprises obtaining a single instance of class Runtime that allows the client daemon program to interface with the environment in which the client daemon is running.

11. The method of claim 1, wherein retrieving output step further comprises making the current thread process to wait until the process represented by this Process object has terminated.

12. The method of claim 1, wherein the steps of storing retrieved output method further comprises the steps of: updating the database; archiving output file in file systems or database.

13. The method of claim 12, wherein archiving step further comprises a unique directory and file timestamp naming convention to uniquely identify every files in the system.

14. The method of claim 13, wherein the timestamp is the system time including year, month, date, hours, minutes, and seconds.

15. The method of claim 12, wherein updating steps further comprises: inserting the binary content of the file and the file link identifier into database table; checking the integrity of the file using crc32 check sum method; resetting status of the job associated with task identifier.

16. A network system for transmitting information among a group of participants, comprising: a server for generating and sending a task identifier associated with a remote program, the server further comprising a web based interface responsive to retrieve the link identifier; and accessing the archived file using values from the link identifier.

17. The network system of claim 16, wherein the link identifier is a Universal Resource Locator.

18. The network system of claim 16, wherein the network is further comprises of Local Area Networks (LANs); Wide-Area-Networks (WANs); and Metropolitan-Area-Networks (MANs).

19. The network system of claim 16, wherein the information further comprises Electronic Data Interchange (EDI) standards as well as other proprietary standards or formats.

20. The method of claim 15, wherein checking steps further comprises: comparing the crc32 value; generating electronic messages.

21. The method of claim 15, wherein resetting status of job is to preventing the server from receiving a task identifier associated with a remote program.

22. The method of claim 20, wherein generating step further comprises transmitting messages via Simple Mail Transfer Protocol (SMTP).
